(19) United States
(12) Patent Application Publication
(10) Pub. No.: US 2006/0167791 A1
(43) Pub. Date: Jul. 27, 2006

(54) Multi-party transaction processing system and approach

(76) Inventor: Dean W. Hahn-Carlson, Lilydale, MN (US)

Correspondence Address: Crawford Maunu PLLC, Suite 390, 1270 Northland Drive, St. Paul, MN, 55120, US

(21) Appl. No.: 11/316,381

(22) Filed: Dec. 22, 2005

Related U.S. Application Data
(60) Provisional application No. 60/639,998, filed on Dec. 29, 2004.
(60) Provisional application No. 60/639,999, filed on Dec. 29, 2004.

(51) Int. Cl. G06Q 40/00

(52) U.S. Cl. 705/39

(57) ABSTRACT

Transaction management for processing payment-related aspects of transactions is facilitated. According to an example embodiment of the present invention, a transaction management approach involves the automatic processing of payments to multiple parties with payment chains extending through intermediary sellers. In some instances, an intermediary seller contracts with a buyer for goods and/or services, and further contracts with one or more performing sellers (e.g., suppliers) for the provision of the goods and/or services. In these instances, funds designated to the buyer (e.g., from a buyer's account or credit line) are transferred to the performing seller or parties in a manner commensurate with the contract between the intermediary seller and the performing seller or sellers. Additional funds are transferred from the buyer to the intermediary seller commensurate with the contract between the buyer and the intermediary seller, less any amount paid to the performing seller or sellers for a particular transaction.

### RELATED PATENT DOCUMENTS

This patent document claims benefit under 35 U.S.C. § 119 to U.S. Provisional Patent Application No. 60/639,999, entitled “Multi-party Transaction Processing System and Approach” and to U.S. Provisional Patent Application No. 60/639,998, entitled “Multi-supplier Transaction and Payment Programmed Processing System and Approach,” both of which were filed on Dec. 29, 2004.

### FIELD OF THE INVENTION

The present invention is directed to communications and data processing involving audits for relatively complex transactions due to the number of parties involved in the transactions.

### BACKGROUND

Operational management of contractual and transactional interactions between buyers, sellers, financial institutions and others involved in the exchange of products for purposes of commerce have typically been labor and time intensive. Generally, the processes of managing transactions between business entities have been unduly burdensome and inefficient.

Many transactions involve a variety of parties at different levels of payment hierarchy. For example, when an intermediary seller sells products or services to a buying party, it often sources (i e., purchases) some or all of the products or services from a performing seller (e.g., a supplier). The performing seller performs according to a contract with the intermediary seller, with the goods and/or services being tendered upon the buying party either directly or indirectly. The intermediary seller invoices the buying party for the transaction, who pays the intermediary seller according to terms of a contracted price between the buying party and intermediary sellers. The performing seller accordingly invoices the intermediary seller for the transaction according to terms of a contracted price between the intermediary seller and performing sellers.

Another example multiparty transaction involves shipping transactions. In many shipping transactions, there is often a shipper (the entity arranging for shipment of the goods), a carrier (the entity carrying goods) a seller (the entity selling the goods) and a buyer (the entity receiving the goods). Often, the seller acts as the shipper and arranges for shipment of the goods. In this regard, the shipper acts as an intermediary seller and the carrier acts as a performing seller.

In other transactions, a seller contracts with a buyer who simply buys services or goods. The seller sometimes performs the contract. In other times, the seller contracts with a supplier to perform some or all of the contract (i.e., provide some or all of goods and/or services). In this instance, the seller acts as an intermediary, with the buyer agreeing to pay an amount contracted between the seller and the buyer. The seller in turn agrees to pay the supplier an amount contracted between the seller and supplier.

In each of the above examples, various invoices and related activities (accounting, adjustments, etc.) are required for each contract in the chain of contracts between buying, intermediary and other parties. These activities are time consumptive, subject to error and often duplicative in nature. For example, at the payment step, financial institutions representing different parties to the transaction must interact with each other. This interaction typically involves complex agreements and associations that facilitate the transfer of funds. At times, there can be delays in payment or disputes regarding terms of payment. In addition, this process is highly susceptible to error. Complexity of interparty interaction, delay, administrative errors and a multitude of other hindrances associated with processing payment can cost one or more parties to a transaction (including financial institutions) a significant amount of funds.

Most industries are quite competitive and any cost savings are therefore important. Administrative costs are targeted for reduction as no revenue is directly generated from administrative functions. However, administrative costs associated with commercial transactions have been difficult to reduce in the current business environment with widely diffused data.

The above and other difficulties in the management and coordination of business transactions have presented administrative and cost challenges to business entities involved in various aspects of transactions, including those involving financial institutions and others.

### SUMMARY

The present invention is directed to overcoming the above-mentioned challenges and others related to the types of devices and applications discussed above and in other applications. The present invention is exemplified in a number of implementations and applications, some of which are summarized below.

According to an example embodiment of the present invention, payment is effected from an owing party to an owed party as a function of contracts between the owing party and an intermediary party, and between the intermediary party and the owed party.

According to another example embodiment of the present invention, an automated transaction processing system is adapted for facilitating a pay-through-payment transaction between a buyer, an intermediary seller and a third performing seller. The system is adapted to access transaction information for a purchasing transaction between the buyer and the intermediary seller, and for a fulfillment transaction between the intermediary seller and the performing seller, which fulfills at least a portion of the purchasing transaction. Payment is facilitated directly on behalf of the intermediary seller to the performing seller as a function of the fulfillment transaction. Further payment is facilitated on behalf of the buyer to the intermediary seller as a function of the purchasing transaction and the fulfillment transaction, with the payment being determined as a difference between the payment and fulfillment transaction values.

In some instances, the above-discussed payment is effected on behalf of the buyer in a manner that mitigates or prevents the buyer from ascertaining the amounts paid to the seller and the performing seller. In other instances, the above-discussed payment is effected on behalf of the buyer while mitigating or preventing the buyer from ascertaining the identity of the performing seller.

The above summary of the present invention is not intended to describe each illustrated embodiment or every implementation of the present invention. The figures and detailed description that follow more particularly exemplify these embodiments.

### BRIEF DESCRIPTION OF THE DRAWINGS

The invention may be more completely understood in consideration of the detailed description of various embodiments of the invention in connection with the accompanying drawings, in which:

FIG. 1 shows a transaction processing arrangement and approach, according to an example embodiment of the present invention;

FIG. 2 shows an arrangement and approach for managing shipping-related transactions, according to another example embodiment of the present invention;

FIG. 3 shows an arrangement and approach to processing payment for transactions involving a pay-through-payment approach, according to another example embodiment of the present invention; and

FIG. 4 shows a flow diagram for transaction payment processing, according to another example embodiment of the present invention.

While the invention is amenable to various modifications and alternative forms, specifics thereof have been shown by way of example in the drawings and will be described in detail. It should be understood, however, that the intention is not necessarily to limit the invention to the particular embodiments described. On the contrary, the intention is to cover all modifications, equivalents, and alternatives falling within the spirit and scope of the invention as defined by the appended claims.

### DETAILED DESCRIPTION

The present invention is believed to be applicable to a variety of different types of communications and financial process management approaches, and has been found to be particularly useful for applications involving the implementation and application of payment-related transaction processes and related aspects thereof. While the present invention is not necessarily limited to such approaches, various aspects of the invention may be appreciated through a discussion of various examples using these and other contexts.

According to an example embodiment of the present invention, a payment management approach involves a pay-through payment process using funds designated to a buyer, who contracts with an intermediary seller for a transaction, to a performing seller who provides transaction items (e.g., goods and/or services) under terms of a contract with the intermediary seller.

In some applications, payment is made directly from the buyer's funds to the performing seller, such as via a banking account or from a credit issuing institution with which the buyer has a credit issuing agreement. This approach alleviates separate payments on behalf of the buyer to the intermediary seller and in turn on behalf of the intermediary seller to the performing seller.

In some applications, a contract between an intermediary seller and a performing seller is underwritten using funds designated to the buyer. For example, where an intermediary seller is generally a transaction intermediary without significant capital, using funds made available by the buyer to underwrite a contract (transaction) for the intermediary may facilitate financial aspects of the transaction. Financing for the underwritten contract is provided by funds designated to the buyer. In some instances, a fee is assessed for the underwriting function and applied against any funds provided by the buyer for payment to the intermediary seller.

According to another example embodiment of the present invention, a payment chain approach facilitates payments made on behalf of a buying (or owing) party to an intermediary seller and on behalf of the intermediary seller to a performing seller for a transaction involving all three parties, using funds designated to the buying party. The buying party generally pays an amount that is based on a contract between the buying and intermediary sellers in response to a single funding request from the intermediary seller. The transaction processing system is configured to then pay each selling party (intermediary and performing sellers) an amount that is commensurate with a contract between the performing seller and intermediary sellers. In some instances, this contract between the performing seller and intermediary seller reflects a one-time spot purchase price for a particular good and/or service.

The intermediary seller is effectively paid an amount that is the difference between what the buying party pays and what the performing seller or parties are paid. In this regard, the intermediary seller is paid a markup relative to the actual cost to the performing seller (and, in some instances, uses rules to automatically apply a markup in automatic transaction negotiation). Funds designated to the buying party (e.g., a banking account or credit line) are transferred to the performing seller (or parties) account(s), and any difference is paid on behalf of the buying party to the intermediary seller. In the instance where the total amount the buying party pays is less than the intermediary seller owes the performing seller or sellers (i.e., the intermediary seller undergoes a loss), funds are also transferred from an account for the intermediary seller to the performing seller or parties.

According to another example embodiment of the present invention, a central transaction system facilitates multi-tiered payment involving a payer party (e.g., a buyer) and two or more payee parties (e.g., intermediary sellers and/or performing sellers/suppliers). The central transaction system is programmable for carrying out a variety of multi-tiered payments, such as those involving one or more of the approaches discussed above. The central transaction system interacts with each of the parties to the transaction and uses transaction information (e.g., contract terms, user profiles for each party and more) to assess payment related terms. Once payment terms are set, the central transaction system uses the terms to effect payment, which includes automatically determining an amount that each of the payee parties is to be paid and facilitating a transfer of funds from the payer party to the payee parties.

In another example embodiment of the present invention, the central transaction management system uses business rules (e.g., included in user profile information) associated with transaction parties to process financial transactions (i.e., payment) among the parties. When the central transaction management system receives transaction information, the information is associated with transaction parties and/or a particular transaction. The association typically involves matching the transaction information with known information stored in a database, such as party identification information and/or transaction identifying information. The central transaction management system uses business rules for the associated parties and/or transaction to process the financial transaction. For instance, the central transaction management system implements, where applicable, contract price terms associated with the transaction to determine a payment amount from a buyer to performing and intermediary sellers to the transaction such as discussed above.

Business rules and/or contract information used by the central transaction management system may be stored using one or more of a variety of approaches. In one implementation, a database accessible by the central transaction management system is used to store labels or other identifying characteristics that associate the business rules with a particular transaction party. This database can be physically local or remote to the central transaction management system, as long as the central transaction management system can access the database and control access to the database by other entities.

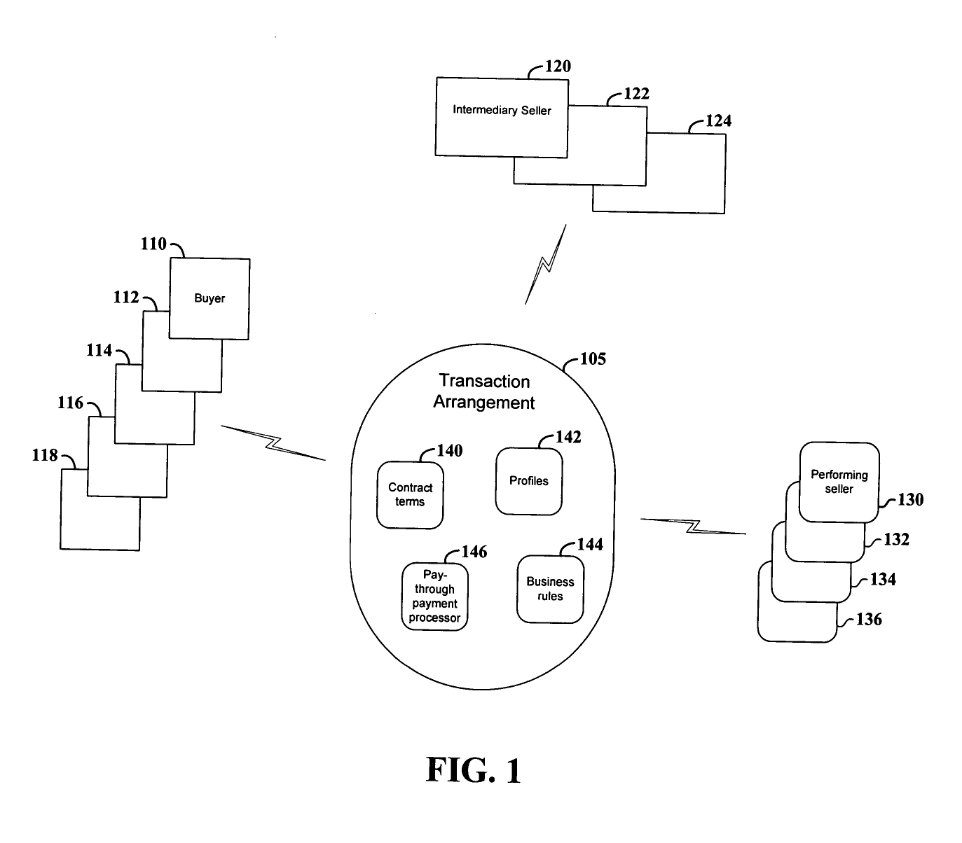

Turning now to the figures, FIG. 1 shows a transaction processing arrangement and approach, according to another example embodiment of the present invention. A transaction arrangement 105 manages payment for transactions between buyers and performing parties that perform in accordance with goods and/or services for which the buying parties make payment. Here, a plurality of transaction parties including buyers 110-118, intermediary sellers 120-124 and performing sellers 130-136 are shown by way of example. While certain buyers, intermediary sellers and performing sellers are shown, this example embodiment and related approaches are applicable to a multitude of such parties, as well as to additional types of transactional parties, as may be involved with a variety of situations.

The transaction arrangement 105 stores, locally or remotely, profiles 142 for each of the parties involved in the transaction. In addition, the transaction arrangement 105 may implement contract terms 140 and business rules 144, stored with the profiles 142 or otherwise. In some instances, the profiles 142 include the business rules 144 and/or contract terms 140 for use in carrying out transactions, as well as other information relating to the user (e.g., buyer, seller or intermediate seller), such as information regarding an agreement between the transaction arrangement 105 and the user. Access control information, such as user identification and password information, is stored with each user's profile and used to control access to the party's profile information. In addition, sufficient financial information (e.g., financial institution account information) for carrying out a transfer of funds for a particular party is also stored with the profile information. With this profile information, the transaction arrangement 105 can process transactions for a particular party (using a pay-through payment processor 146) as well as identify the party and allow the party to access its profile information.

Information regarding a financial institution associated with the transaction arrangement 105 (i.e., an entity operating the transaction arrangement) can also be stored with the transaction arrangement and used for depositing fees associated with the facilitation of transactions. In some instances, the transaction arrangement 105 provides an underwriting function on behalf of an intermediary seller, e.g., as described above, with funds initially being provided to a performing seller via the financial institution associated with the transaction arrangement. Funds designated to the buyer for the transaction involving the performing seller are then used to finance the underwritten funds. Fees associated with the financed underwritten funds are correspondingly assessed to the intermediary seller and, in some instances, are taken from funds provided by the buyer for payment to the intermediary seller.

Each of the buyers 110-118 contracts with one or more of the intermediary seller (120-124) or performing seller (130-136) parties for transactions. In turn, where one of the intermediary sellers 120-124 contracts with a buyer, that intermediary seller optionally subcontracts with one or more of the performing sellers 130-136 to perform in accordance with the contract with the buyer. In this regard, the transaction arrangement 105 identifies contract terms (optionally implemented with contract terms 140) using profiles 142, business rules 144 or other transaction-related information, and uses the contract terms to effect payment. When a particular buyer owes for a particular transaction, the transaction arrangement 105 transfers funds from the buyer's financial institution to the intermediary and performing sellers involved in the transaction. When a particular buyer owes an intermediary seller for goods or services provided by an owed (performing seller) party, the pay-through payment processor 146 facilitates direct payment from the particular buyer to the owed party. Each seller receives an amount commensurate with its contract with the intermediary party. The intermediary seller receives an amount that is commensurate with its contract with the buyer, less any amount paid to performing sellers.

In some applications, an agreement between a party operating the transaction arrangement 105 and the participating transactional parties involves a transaction-based fee assessed to one or more parties to a transaction. These fees may be applied to one or more of the parties to the transaction, depending upon the nature of the transaction, contractual agreements with transaction parties and other considerations. In some applications, this fee is assessed to a seller (or intermediate seller) by taking a percentage of a selling price for a particular transaction. In some applications involving multiple selling parties for a particular transaction, the transaction arrangement 105 assesses a fee to each selling party that corresponds to a portion of a total transaction amount that the particular selling party is receiving. For instance, where an intermediary seller contracts with a buyer and accordingly subcontracts to a performing seller for the same transaction, the intermediary and performing sellers are assessed fees commensurate with the amount that each party is respectively paid. In some applications, the pay-through payment processor 146 assesses fees accordingly to the intermediary and performing sellers.

In other instances, the contract terms 140 specify how fees are to be assessed among parties. For example, where an intermediary seller pays for all fees, a performing seller is effectively an outside participant. In this regard, an outside participant may not necessarily have an established agreement (and according contract terms 140) with the party operating the transaction arrangement 105. Here, the intermediary seller would be assessed transaction-based fees for any amount paid to the intermediary seller as well as for amounts paid to performing sellers. Various other contractual arrangements are similarly implemented at the transaction arrangement 105 via contract terms 140 and the pay-through payment processor 146 to suit particular transaction needs.

The following application example describes one type of financial transaction involving the buyer 110, intermediary seller 120 and two performing sellers 130 and 132. Here, the buyer 110 contracts with the intermediary seller 120 for a shipping transaction for moving goods between origin and destination locations. The contract terms are stored as contract terms 140. Each of the buyer 110, intermediary seller 120 and performing sellers 130 and 132 has profiles stored with the profiles 142. Business rules for the parties are stored as business rules 144. In some instances, the origin and destination locations are in different municipalities, states or countries that have different transaction (e.g., shipping) rules, where each carrier (selling party) operates according to business rules for the respective locations. The intermediary seller 120 in turn contracts with the performing seller 130 (a carrier) to carry the goods from the origin location to a transit location. The intermediary seller 120 further contracts with the performing seller 132 to carry the goods from a transit location to the destination location.

In some instances, the intermediary seller 120 carries the goods for a portion of the transit route along which the goods are passed. This intermediary seller transit is carried out, e.g., instead of or in addition to the above-discussed routes, which one of the performing sellers 130 and 132 would otherwise implement. In this regard, the intermediary seller 120 acts as both a performing seller and an intermediary seller, with funds being transferred accordingly by the transaction arrangement 105.

In the above application example, when payment is made for the transaction, the transaction arrangement 105 facilitates the transfer of funds to each appropriate party according to contract (e.g., transaction profile) information. For example, when the intermediary seller 120 issues an invoice and the buyer 110 approves the invoice, the transaction arrangement 105 identifies amounts owed to each of the performing sellers 130 and 132. This identification may be carried out at the pay-through payment processor 146, which also facilitates the transfer of funds to the proper recipient. Funds are transferred from the buyer 110's financial institution to each of the performing sellers 130 and 132 (via the pay-through payment processor 146) according to price terms identified in contracts between the respective performing sellers and the intermediary seller 120. Funds are also transferred from the buyer 110's financial institution to the intermediary seller 120 according to price terms identified in the contract between the intermediary seller 120 and buyer 110 parties, less any amount paid to the performing sellers 130 and 132.

In one implementation, the transaction arrangement 105 uses access information, such as passwords and other security measures, to enable parties to a transaction to see certain limited information for a particular transaction. For instance, using the above application example again, the buyer 110 may be granted access to information that identifies a shipment status, but is not granted access to information regarding the actual performing seller 130 or 132. Similarly, each performing seller 130 and 132 may respectively be granted access to information regarding its portion of the shipping transaction, such as payment status, but not be granted access to information regarding the actual buyer 110 or other selling party.

In another implementation, the transaction arrangement 105 facilitates the negotiation and/or settlement of conflicting contract information using business rules for parties to the transaction. For instance, where contract term rules conflict, acceptance or flexibility for alternate rules or variations on the rules can be implemented for automatically adjusting the contract.

In another example embodiment, the transaction arrangement 105 facilitates accounting from a line item perspective, with information being provided to financial institutions representing transaction parties and/or directly to transaction parties. Unit prices and extended charges for items or services that are the subject of a transaction are separated from line items. From a logical design standpoint in certain implementations, each transaction has one or more line items, and each line item can be serviced by one or more providers (e.g., supply chain partners). Each combination of a line item and one or more supply chain partners has an expected and billed cost (both unit and extended). That is, where a line item is for a particular transaction item, that line item along with the one or more providers (e.g., goods or service providers, as intermediary or performing parties) that fulfill the transaction item are associated with an expected and billed cost. Supply chain partners can exist either as sequential providers with additive payment chain effects on the payer or as resellers with the ultimate payer having no visibility to the distribution of the payment between the two adjacent payment chain members. Referring back to FIG. 1 and the above application example embodiment, the intermediary seller 120 is a supply chain partner with each of the performing sellers 130 and 132, with the shipping service being the subject of a single line item. The supply chain for the single line item includes the intermediary party and, one step down the chain, the selling parties.

Referring again to FIG. 1, the transaction arrangement 105 is adapted to enable access to transaction information for parties to the transaction as a function of user profiles and/or business rules, according to another example embodiment of the present invention. Where a transaction involves separate contracts between an intermediary party and a buyer and seller(s), the buyer and seller(s) are given limited access for viewing information about each other. For example, where an intermediary party contracts with a buyer for a transaction at a particular amount, and separately contracts with a seller to fulfill the transaction at a different (i.e., lower) amount, the specific amounts may desirably be kept proprietary. In this regard, the seller is not allowed access to the transaction arrangement 105 that would identify the amount or, in some instances, the buyer. The buyer is restricted similarly. This access approach may be implemented using, for example, profile information or business rules for the intermediary.

In other implementations, the transaction arrangement 105 permits access to selected information while maintaining guarded access to related information. For instance, a buyer may be allowed to check the status of an order shipment from a seller without being given access to the seller's identification. Similarly, the seller may be allowed to check the status of acceptance of goods and/or services by the buyer, without being access to the buyer's identification.

Again referring to FIG. 1, another example embodiment is directed to payment processing for a transaction as a function of contracts between one of the buyers and one of the performing sellers. A separate contract (reflected, in some instances, in business rules 144), between one or both of the one of the buyers and one of the performing sellers, and one of the sellers (intermediary sellers) is further used in the processing. For example, a buyer 110 may contract directly with a performing seller 130 who hires an intermediary seller 120, such as a customer service representative or a third party logistics entity, to oversee or otherwise facilitate the transaction. A contract price may be set between the buyer 110 and the performing seller 130, with a portion of the contract price (e.g., a set fee and/or a percentage of the contract price) going to the intermediary seller 120. Payment is carried out by the pay-through-payment processor 146, facilitating payment from the buyer 110 to intermediary seller 120 and performing seller 130.

As another example, a buyer 110 may contract directly with a performing seller 130, with the buyer further contracting with an intermediary managing seller 120 who facilitates the transaction. The contract price is again set between the buyer 110 and the performing seller 130, with a portion of the contract price going to the intermediary managing seller 120 (e.g., with the performing seller 130 agreeing to the intermediary managing seller being paid from the contract price). Similar to the preceding approach, the pay-through-payment processor 146 again carries out payment, facilitating payment from the buyer 110 to intermediary managing seller 120 and performing seller 130.

In another embodiment, two or more performing sellers supply products and/or goods in connection with a particular transaction, within a hierarchical relationship. For example, referring to FIG. 1, a transaction between buyer 110 and intermediary seller 120 for goods from performing seller 120 may involve goods from another performing seller 132. The performing seller 120 thus acts as a performing seller and as an intermediary seller as discussed above. For instance, where an order “X” from the buyer 110 to the intermediary seller 120 includes goods “A” and “B”, the intermediary seller may contract with the performing seller 130 to supply all goods “A” and “B.” The performing seller 130 in turn may source some or all of the goods “A” and/or “B” from performing seller 132. Terms of the agreements involving all parties are stored with the transaction arrangement 105, with payment being effected on behalf of the buyer 110 to the intermediate seller 120, and (using funds from the buyer 110) on behalf of the intermediate seller to the performing sellers 130 and 132 in the respective amounts that each seller is owed.

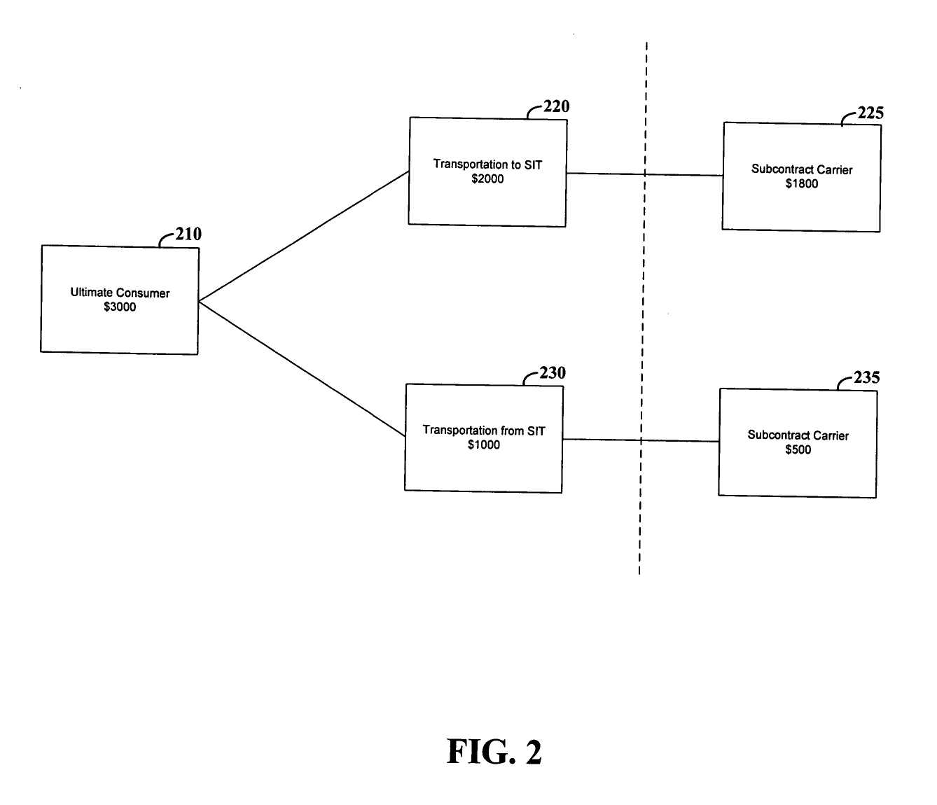

FIG. 2 shows a payment-related approach for use with shipment transactions involving a shipper and one or more carriers and/or carrier brokers, according to another example embodiment of the present invention. For general information regarding transactions and for specific information regarding shipping type transactions and approaches that may be implemented in connection with the present invention, reference may be made to U.S. Pat. No. 5,910,896 to Hahn-Carlson, which is fully incorporated herein by reference.

In this instance, a consumer 210 (e.g., shipper or buyer) contracts with two different transportation entities 220 and 230 (e.g., intermediate sellers) to respectively transport goods from an origin to a transit location and from a transit location to a destination. Each of transportation entities 220 and 230 accordingly subcontracts the shipment of the goods to respective subcontract carriers 225 and 235 (e.g., performing sellers).

The total cost of the shipment for the consumer 210 is $3000, including $2000 contracted with transportation entity 220 and $1000 contracted with transportation entity 230 (which may also include funds for paying for the shipment being placed in a transit location). Subcontract carrier 225 charges $1800 for the portion of the shipment to the transit location, and subcontract carrier 235 charges $500 for the portion of the shipment from the transit location.

The consumer 210 may not have visibility to fact that each transportation entity of record has subcontracted the work to someone else (the subcontract carriers). However, the consumer generally desires information regarding the shipment process. In this regard, information regarding the shipment transaction is provided to the consumer while protecting information, where business rules of the transportation entities (or otherwise) protects the information.

In addition, the subcontract carriers 225 and 235 may not necessarily have access to information regarding the consumer 210 or any contract between the consumer and the corresponding transportation entity with which it is subcontracted. Similarly, each respective carriers 225 and 235 may not have knowledge of the portion of the shipment effected by the other respective carrier.

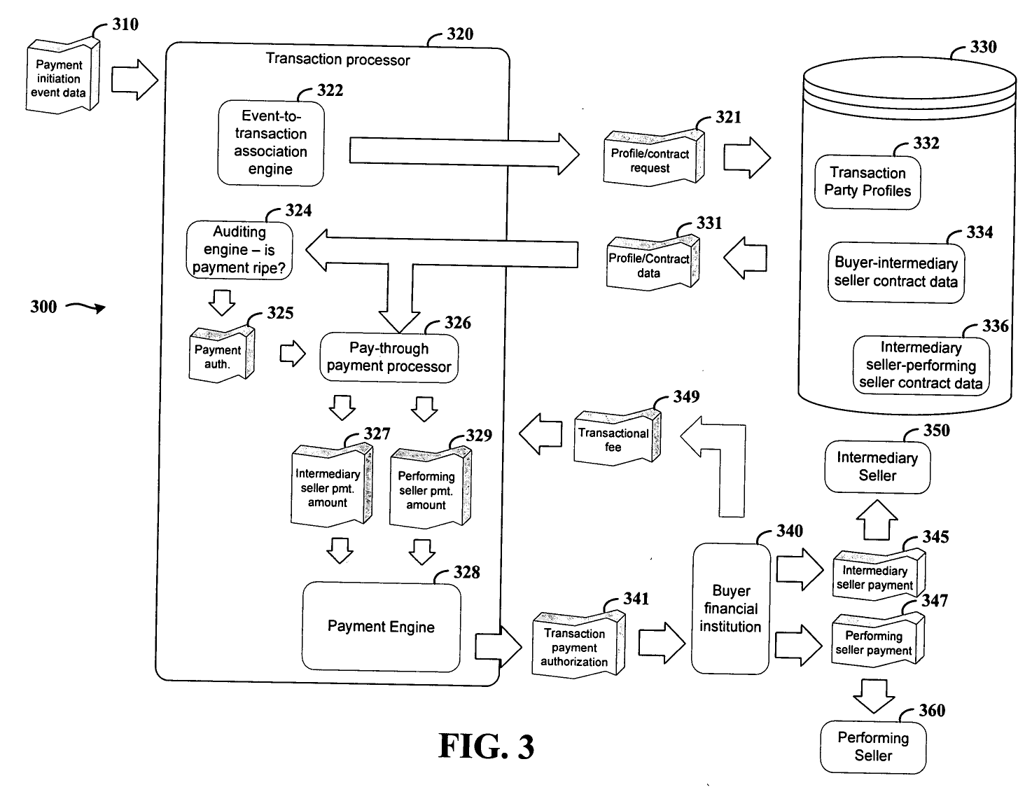

FIG. 3 shows an arrangement 300 with an associated approach to processing transactions involving payment from a buyer to an intermediary seller, and a pay-through-payment from the buyer, through the intermediary seller to a performing seller with whom the intermediary seller contracts, according to another example embodiment of the present invention. The arrangement 300-includes a transaction processor 320 and a data storage arrangement 330, which is selectively implemented across many local or remote data storage devices. A buyer financial institution 340 makes payment to intermediary and performing sellers at the direction of the transaction processor 320.

When payment initiation event data 310 is received at the transaction processor 320, a payment process is initiated. The payment initiation event data 310 may, for example, be one or more of the following: an invoice, a receipt, an acceptance of goods or other communication from a transaction party. In some instances, the payment initiation event data 310 is automated payment data such as that associated with a recurring transaction, and is selectively generated at the transaction processor.

An event-to-transaction association engine 322 associates the payment initiation event data 310 with a particular transaction and, accordingly, with a particular set of transaction parties involved in the transaction. To facilitate this association, the event-to-transaction association engine 322 generates a profile/contract request 321 to the data storage arrangement 330, which returns profile/contract data 331 that corresponds to the payment initiation event data 310. This profile/contract data 331 is drawn from data stored with transaction party profiles 332, buyer-intermediary seller contract data 334 and intermediary seller-performing seller contract data 336 stored, for example, at an earlier time on behalf of one or more parties to the transaction. Using this information, transaction parties are identified; for purposes of this example (and for brevity), a transaction involving a buyer purchasing goods and/or services from an intermediary seller is described, with the intermediary seller separately contracting with a performing seller who provides the goods and/or services.

An auditing engine 324 uses the profile/contract data 331 as well as the payment initiation event data 310 to determine whether payment is ripe or otherwise appropriate. For instance, where the buyer's profile indicates that all invoices from a particular intermediary seller are to be paid immediately, such an invoice included with the payment initiation event data 310 is used to accordingly determine that payment is ripe. In certain applications, the payment initiation event data 310 is compared with stored buyer-intermediary seller contract data to ensure that a payment amount is correct, and if so, payment is determined to be ripe. Under these or other circumstances, when payment is appropriate the auditing engine-324 generates a payment authorization that is sent to a pay-through payment processor 326.

The pay-through-payment processor 326 also uses the profile/contract data 331, together with the payment authorization 325, to determine and output a payment amount 327 for the intermediary seller and a payment amount 329 for the performing seller. A payment engine 328 uses the payment amounts 327 and 329 for the intermediary and performing sellers and provides a transaction payment authorization 341 for use in processing payment from the buyer. The transaction payment authorization 341 includes information for use in effecting an appropriate payment to each of the intermediary and performing sellers and, where appropriate, to effect a transaction processing fee directly from the buyer's funds (e.g., taken from an amount owed to one or both of the sellers as may be indicated in the profile/contract data 311).

A buyer financial institution 340 uses the transaction payment authorization 341 to generate a payment 341 to the intermediary seller 350 and a payment 343 to the performing seller 360. Where appropriate, the buyer financial institution 340 also generates a payment for a transactional fee 349 and applies that payment to the transaction processor 320 (i.e., to an entity operating the transaction processor). In some applications, the buyer financial institution 340 effectively extends credit to the buyer in order to make the appropriate payments, and maintains a related credit account for the buyer. In certain applications, the buyer financial institution 340, whether drawing funds directly from or extending credit to the buyer, is incorporated with the transaction processor 320, wherein appropriate transaction fees as addressed within the processor.

In the above examples describing approaches to that shown in FIG. 3, various components are included in one or more common arrangements and selectively include additional features to facilitate transactions (e.g., as included in the patent documents incorporated herein). For instance, the pay-through payment processor 326 is selectively implemented with the payment engine 328 and/or with the event-to-transaction association engine 322 and the auditing engine 324. Furthermore, one or more of the components or arrangements shown in and discussed in connection with FIG. 3 are selectively implemented with a computer arrangement, such as via software-implemented applications that carry out one or more of the described functions.

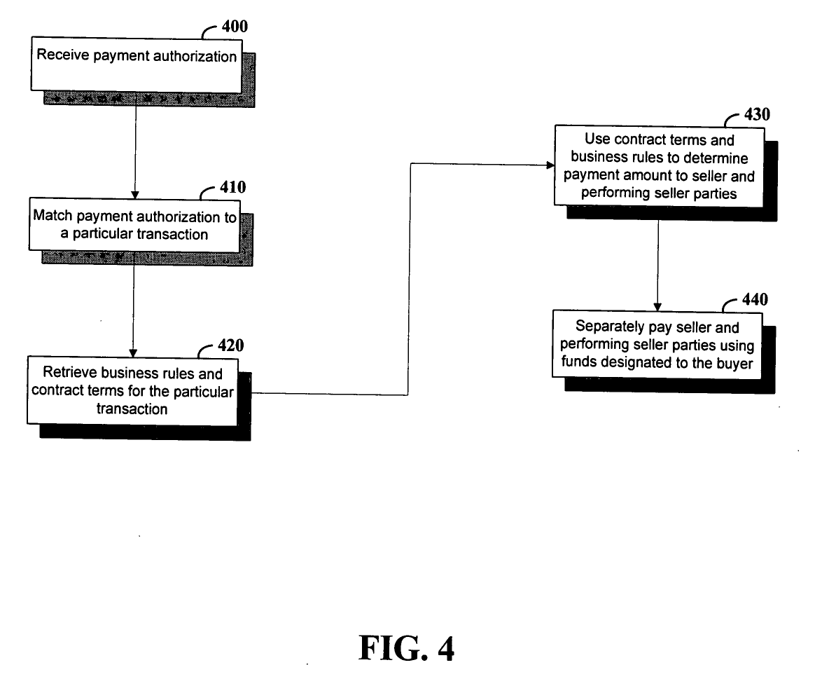

FIG. 4 is a flow diagram for an approach to processing business transactions involving a buying party and at least two paid parties, according to another example embodiment of the present invention. At block 400, payment authorization for a particular transaction is received and processed. The payment authorization is matched to a particular transaction at block 410. The matching may involve using, for example, transaction-identifying or party-identifying information in the payment authorization. This matching approach may be implemented using, for example, one or more of the embodiments and implementations described in connection with U.S. patent application Ser. No. 10/864,761 (USBA.120PA), filed Jun. 9, 2004, which is fully incorporated herein by reference.

At block 420, business rules and contract terms for the particular transaction are retrieved, and used at block 430 to determine a payment amount to intermediary and performing sellers. In this scenario, the intermediary seller is involved in a direct contract with the buyer and the performing seller performs some or all of the transaction to which the direct contract is directed, at the direction of the intermediary seller. Retrieving business rules and contract terms typically involves using the association (matching) at block 410 to identify one or more sets of rules or terms applicable to parties to the transactions and/or specific to the transaction itself. For example, where two parties have standing contract terms (e.g., specifying a percentage of a transaction price that an intermediary seller it to be paid) that are not transaction-dependent, those terms can be used for different transactions to which the terms apply. Where parties contract specifically for a particular transaction, contract terms relating to that transaction are used. For general information regarding the use of business rules and contract terms, and for specific information regarding transaction processing approaches that may be implemented in connection with one or more example embodiments discussed here, reference may be made to U.S. patent application Ser. No. 10/436,878 (USBA.101PA), filed May 12, 2003, which is fully incorporated herein by reference.

After the respective payment amounts have been determined at block 430, the seller and performing sellers are paid at block 440 using a pay-through-payment approach drawing funds designated to the buyer to pay the intermediate seller and to pay through the intermediate seller to the performing seller. For instance, where the funds come directly from a financial institution designated by the buyer (e.g., in the buyer's business rules or profile), the buying party's financial institution is instructed to make a payment in an amount commensurate with a contract between the buying party and the seller, but splits the payment into two portions. A first portion of the payment is made to the performing seller, at an amount set by a contract between the intermediary seller and performing seller. A second portion of the payment is made to the intermediary seller, at an amount that is defined as a difference between an amount contracted between the intermediary seller and buying party or parties, and the amount paid to the performing seller.

While certain aspects of the present invention have been described with reference to several particular example embodiments, those skilled in the art will recognize that many changes may be made thereto without departing from the spirit and scope of the present invention. For example, contract terms described may be implemented in the form of business rules for a particular entity and may further be facilitated by the entity's user profiles. In addition, a multitude of different types of transaction parties, at different levels, may be implemented using the above discussed approaches. For instance, where instances of performing sellers are described, one or more tiers of such performing sellers may be implemented, wherein each performing seller can thus act as an intermediary seller. Aspects of the invention are set forth in the following claims.

What is claimed is:

1. An automated transaction arrangement for processing payment for transactions characterized by contract terms between a buyer and an intermediary seller and by contract terms between the intermediary seller and a performing seller, the arrangement comprising:
a data storage arrangement adapted to store contract terms and business rules for transaction parties, the contract terms including data for auditing and effecting payment to intermediary and performing sellers involved in a common transaction, the business rules including financial processing data for effecting funds transfer for the parties to each transaction; and
an automatic transaction processor adapted to automatically process payment for each transaction using funds designated to the buyer in the transaction, by paying intermediary and performing seller parties as a function of the stored contract terms for the transaction and the business rules information for the buyer and at least one of the intermediary seller and the performing seller.

2. The automated transaction arrangement of claim 1, wherein the automatic transaction processor is further adapted to effect payment for the transaction to the intermediary seller in an amount that is the difference between an amount that the intermediary seller is owed by the buyer and an amount that the performing seller is owed by the intermediary seller as defined by the stored contract terms.

3. The automated transaction arrangement of claim 1, wherein the automatic transaction processor is adapted to implement the business rules information to provide an underwriting function for the intermediary seller for the contract between the intermediary seller and the performing seller.

4. The automated transaction arrangement of claim 3, wherein the automatic transaction processor is adapted to implement the business rules information to use a payment due from the buyer to provide the underwriting function for the intermediary seller.

5. The automated transaction arrangement of claim 4, wherein the automatic transaction processor is adapted to finance the underwriting by paying the performing seller on behalf of the intermediary seller using funds designated to the buyer when received from the buyer.

6. The automated transaction arrangement of claim 1, wherein the automatic transaction processor is further adapted, in response to the intermediary seller owing more to the performing seller than the buyer owes the intermediary seller, to effect payment on behalf of the intermediary seller to the performing seller in an amount that is equal to the amount that the buyer owes the intermediary seller and to effect payment on behalf of the intermediary seller to the performing seller in an amount that is the difference between the amount that the buyer owes the intermediary seller and that the intermediary seller owes the performing seller.

7. The automated transaction arrangement of claim 1, wherein the automatic transaction processor is further adapted to determine an amount that the intermediary seller is owed as a function of stored contract terms for a contract between the intermediary seller and the performing seller and further as a function of stored contract terms for a contract between the intermediary seller and the buyer.

8. The automated transaction arrangement of claim 7, wherein the automatic transaction processor is further adapted to determine an amount that the intermediary seller is owed as a function of the contract between the intermediary seller and the performing selling party and further as a function of the contract between the intermediary seller and the buyer, by subtracting the amount that the performing seller is owed from the amount that the buyer has contracted with the intermediary seller.

9. The automated transaction arrangement of claim 1, wherein:
the data storage arrangement is adapted to store business rules information that identifies contract characteristics to use in determining amounts that respective parties to a transaction are owed; and
the automatic transaction processor is adapted to access the stored business rules information for the transaction parties and to process payment for the transaction by using the identified contract characteristics to determine the amounts that the intermediary seller and performing seller are respectively owed.

10. The automated transaction arrangement of claim 1, wherein the automatic transaction processor is programmed to automatically assess a fee to at least one of the performing seller and the intermediary seller as a function of an effected payment to the at least one party.

11. The automated transaction arrangement of claim 10, wherein the automatic transaction processor is programmed to assess a fee to the performing seller and to the intermediary seller as a function of an effected payment to each party by assessing a fee that is a percentage of a payment to each party.

12. The automated transaction arrangement of claim 10, wherein the automatic transaction processor is programmed to assess a fee to the intermediary seller as a function of an effected payment to at least one of the parties by reducing an amount of payment to the intermediary seller by the amount of the assessed fee.

13. The automated transaction arrangement of claim 1, wherein the a data storage arrangement is adapted to store access configuration information for configuring access to the automatic transaction processor by transaction parties, and wherein the automatic transaction processor is adapted to selectively limit access to transaction information to each of transaction parties as a function of the stored access configuration information associated with each respective party.

14. The automated transaction arrangement of claim 13, wherein the automatic transaction processor is adapted to prevent the buyer from receiving identification information about the performing seller.

15. The automated transaction arrangement of claim 13, wherein the automatic transaction processor is adapted to limit the performing seller's access to transaction-related information to information specified in configuration of the automatic transaction processor.

16. The automated transaction arrangement of claim 13, wherein the automatic transaction processor is adapted to exclusively provide contract information access to transaction parties who are contract participants.

17. The automated transaction arrangement of claim 13, wherein the automatic transaction processor is adapted to prevent the performing seller from ascertaining a price of the contract between the intermediary seller and the buyer.

18. The automated transaction arrangement of claim 13, wherein the automatic transaction processor is adapted to prevent the buyer from ascertaining a price of the contract between the intermediary seller and the performing seller.

19. The automated transaction arrangement of claim 1, wherein the automatic transaction processor is configured and arranged to automatically process payment for a transaction by paying both an intermediate seller and a performing seller, on using funds designated to the buyer, as a function of separate contracts between the buyer and the intermediary seller and between the intermediary seller and the performing seller.

20. An automated transaction system for processing business transactions involving a plurality of transaction parties including a buyer, an intermediary seller and at least one performing seller, wherein the buyer contracts for a transaction with the intermediary seller and wherein the intermediary seller contracts with the one or more performing sellers to fulfill at least part of the contract between the buyer and the intermediary seller, the system comprising:
data storage means configured and arranged to store contract terms and business rules for the transaction parties;
a pay-through payment processing arrangement adapted to process payment for the transaction by:
determining an amount that each performing seller is owed as a function of the contract between the intermediary seller and the performing seller;
determining an amount that the intermediary seller is owed as a function of the contract between the intermediary seller and the at least one performing seller; and
effecting payment on behalf of the intermediary seller to the at least one performing seller and on behalf of the buyer to the intermediary seller as a function of the determined amounts that each respective party is owed and the stored business rules.

21. The automated transaction arrangement of claim 20, wherein the transaction arrangement is adapted to:
effect payment on behalf of the intermediary seller to the one or more performing sellers and on behalf of the buyer to the intermediary seller as a function of the determined amounts that each respective party is owed by using the stored business rules to identify financial institutions for the buyer, an operator of the transaction processor, the intermediary seller and the one or more performing sellers,
issue payment authorization to the buyer's financial institution for paying a financial institution associated with the operator of the transaction processor, and
issue payment authorization to the financial institution associated with the operator of the transaction processor to then pay the intermediary seller and each performing seller.

22. An automated transaction arrangement for processing payment for a transaction involving a contract between a buyer and an intermediary seller and a contract between the intermediary seller and a performing seller, the arrangement comprising:
means for storing contract and business rules information for parties to the transaction, the contract terms including information relating to the contracts and the business rules information including financial processing information for parties to the transaction; and
processing means for automatically processing payment for the transaction by paying both the intermediary seller and the performing seller, using funds designated to the buyer, as a function of the stored contract terms and the business rules information for the buyer and at least one of the intermediary seller and the performing seller.

23. A method for processing business transactions involving a contract between a buyer and an intermediary seller and a contract between the intermediary seller and a performing seller, the method comprising:
storing contract and business rules information for parties to the transaction, the contract terms including information relating to the contracts and the business rules information including financial processing information for parties to the transaction; and
using an automatic transaction processor, automatically processing payment for the transaction by paying both the intermediary seller and the performing seller, using funds designated to the buyer, as a function of the stored contract terms and the business rules information for the buyer and at least one of the intermediary seller and the performing seller.

24. The method of claim 23, wherein using an automatic transaction processor includes programming the automatic transaction processor to use the stored contract and business rules information to automatically process payment for a transaction by transferring funds, designated to the buyer, to a performing seller on behalf of the intermediary seller and to the intermediary seller on behalf of the buyer as a function of business rules information for the buyer and at least one of the intermediary seller and the performing seller and of the stored contract terms.

25. The method of claim 23, further comprising receiving authorization information relating to a payment authorization condition, wherein automatically processing payment for a transaction includes authorizing the transfer of funds designated to the buyer as a function of the authorization information.

26. The method of claim 25, wherein storing business rules information includes storing user profile information including identification information for transaction parties, and wherein receiving authorization information includes associating the authorization information with a particular party to the transaction as a function of profile information for the party and the authorization information.

27. The method of claim 26, wherein automatically processing payment for a transaction includes using business rules for the party providing the authorization information.

28. The method of claim 23, further comprising determining an amount that the performing seller is owed by the intermediary seller, wherein paying the performing seller includes transferring funds, designated to the buyer, in the amount owed by the intermediary seller to the performing seller, and wherein paying the intermediary seller includes transferring funds in the amount owed by the buyer to the intermediary seller, less the amount owed by the intermediary seller to the performing seller.
